(19) United States
(12) Patent Application Publication
(10) Pub. No.: US 2009/0249932 A1
(43) Pub. Date: Oct. 8, 2009

(54) REED CUTTER DEVICE

(75) Inventor: Bernard VAN DOREN, Le Lavandou (FR)

Correspondence Address: SUGHRUE MION, PLLC, 2100 PENNSYLVANIA AVENUE, N.W., SUITE 800, WASHINGTON, DC, 20037, US

(73) Assignee: VARLEPIC PARTICIPATIONS, Paris (FR)

(21) Appl. No.: 12/419,674

(22) Filed: Apr. 7, 2009

(30) Foreign Application Priority Data
Apr. 8, 2008 (FR) 08 01925
Nov. 14, 2008 (FR) 08 06358

(51) Int. Cl. G10D 9/00; B27M 1/00; B26D 7/01

(52) U.S. Cl. 83/437.4; 83/468; 83/468.7; 83/522.19; 83/685

(57) ABSTRACT

The invention relates to a reed cutter device (1) for cutting the reeds (5) of wind instruments, in which the body of the reed (5) is held on a bed (3) and the end (7) of the reed is able to be cut by the die (45) and punch (47) cutting assembly (9) for cutting to a suitable profile, comprising a device (11) for centering the reed (5) relative to said die and punch cutting assembly (9), provided with a means (19, 35) for advancing the reed longitudinally and with a means (19, 33) for adjusting the transverse position of the end (7) of the reed (5) on said bed (3), and the cutting assembly (9) comprises a punch (47) mounted movably relative to a fixed die (45) mounted on the bed (3), the punch (47), which is mounted on an actuating plunger (13), being able to slide on an axis perpendicular to the plane of the reed (5) or to the plane of the bed (3).

### BACKGROUND OF THE INVENTION

The invention relates to a reed cutter device for cutting the reeds of wind instruments.

### DESCRIPTION OF THE PRIOR ART

It is known that musicians often trim the reeds of their wind instruments in order to maintain or modify the musical qualities of their instruments.

It is an object of the invention to provide a reed cutter device which facilitates this cutting of the reeds of wind instruments.

### SUMMARY OF THE INVENTION

The invention thus provides a reed cutter device for cutting the reeds of wind instruments, in which the body of the reed is held on a bed and the end of the reed is able to be cut by the die and punch cutting assembly for cutting to a suitable profile, comprising a device for centering the reed relative to said die and punch cutting assembly, provided with a means for advancing the reed longitudinally and with a means for adjusting the transverse position of the end of the reed on said bed, and the cutting assembly comprises a punch mounted movably relative to a fixed die mounted on the bed, the punch, which is mounted on an actuating plunger, being able to slide on an axis essentially perpendicular to the plane of the reed or to the plane of the bed.

The result of this arrangement is that the reed cutter according to the invention allows the reed to be positioned on the bed in both the longitudinal and transverse directions and facilitates the cutting by the action of an operator's finger on the plunger to cut the end of the reed.

The adjustment of the longitudinal advance of the reed on its bed can be done by means of a wheel mounted rotatably on said means of longitudinal advance. This wheel includes an index marker enabling the musician to adjust the strength of the reed to the desired level, in other words to vary the thickness of the beveled end.

Said means of longitudinal advance of the reed may comprise at least one eccentric rotary wheel pressed against the end of the reed.

Similarly, the setting of the transverse position of the end of the reed may be done by means of at least one second wheel mounted rotatably on said means of adjustment of the transverse position. This wheel also has an index marker for the precise adjustment of the transverse position of the end of the reed before it is cut.

Said transverse setting means may comprise two wheels set apart from one another, mounted rotationally and eccentrically and pressed against the side of the reed.

Advantageously, said wheel for adjusting the longitudinal advance of the reed and said wheel for the transverse setting of the reed are both mounted on the same movable bar, which bears laterally on a single side through at least two points against the body of the reed, one point close to the beveled end of the reed and one point close to the base of the reed, and a third point below the base of the reed.

The movements of this bar are controlled by means of said wheels, respectively transversely relative to the body of the reed, principally through said point close to the beveled end of the reed, and longitudinally through said point below the base of the reed.

Said wheels may each be mounted with their axis passing through the bar and connected to the bed, each being provided with an eccentric part capable of bearing rotationally against a corresponding bore in the bar in order to move said bar along the longitudinal and transverse axes of movement of the reed.

Said punch may slide on two pillars perpendicular to the plane of the bed and may be returned to its non-use position with the lifting of the plunger by a spring means.

The punch may also be mounted on a spring bridge which can be moved down to the use position and back up to the non-use position.

Part (or all) of the bed is transparent so that the end of the reed can be seen. In addition, said bed may be made of a transparent material, e.g. a hard transparent plastic such as Plexiglas®. This feature allows the end of the reed to be seen through the bed, so that adjustments to the cutting of the reed can be checked and corrected.

The invention is set forth below with the help of an illustrative embodiment of the invention, with reference to the appended drawings, in which:

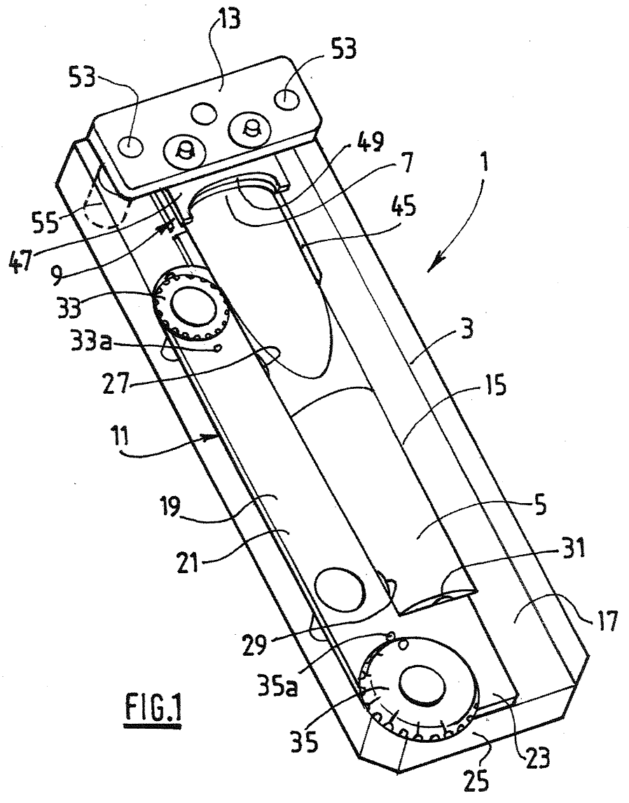

FIG. 1 is a perspective view of a reed cutter according to the invention,

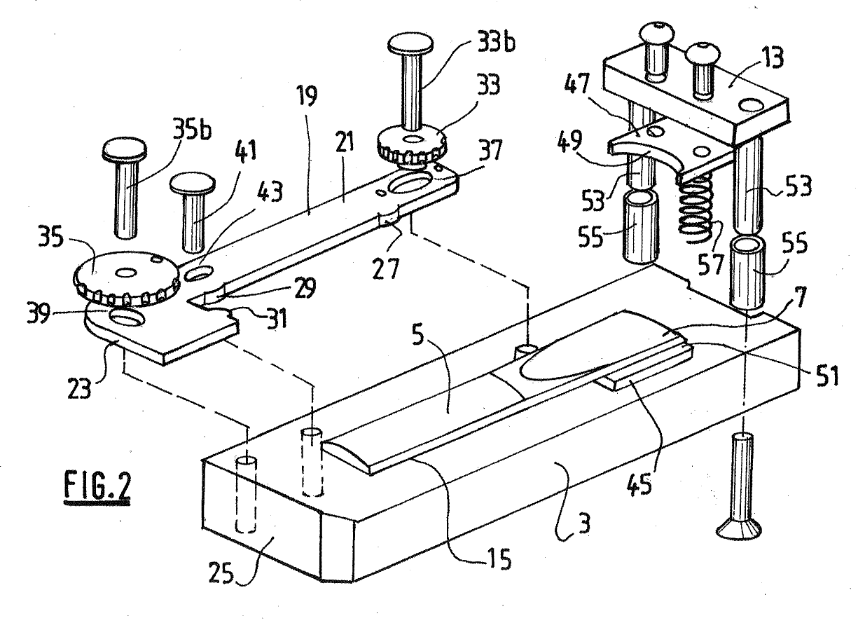

FIG. 2 is an exploded view of the reed cutter seen in FIG. 1,

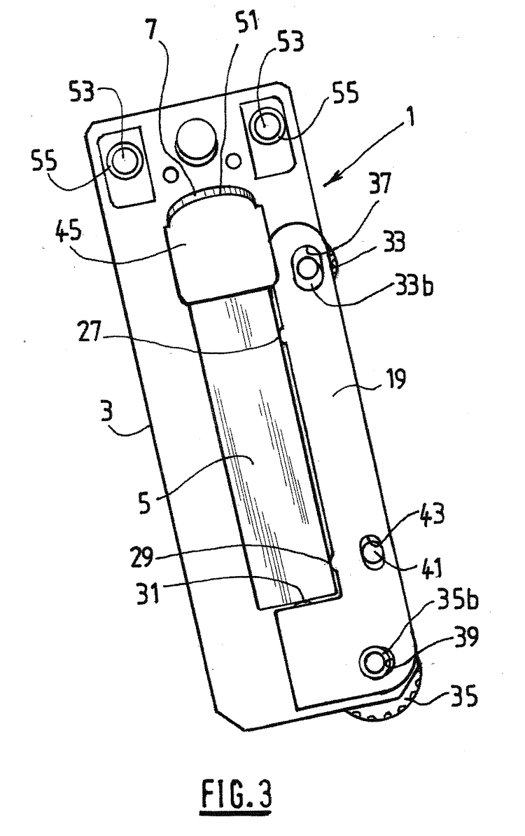

FIG. 3 is a bottom view of the reed cutter seen in FIG. 1, and

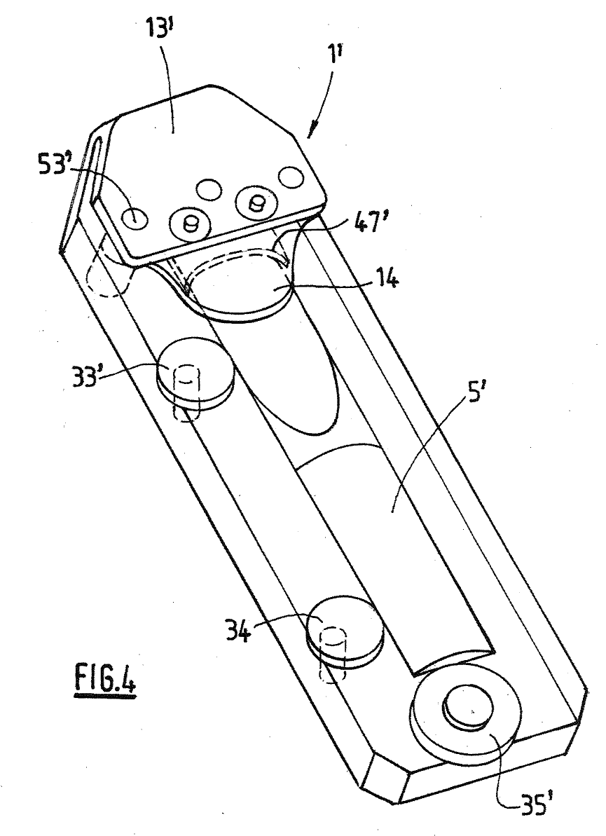

FIG. 4 is a schematic perspective view of a reed cutter device in a variant of the invention.

### DESCRIPTION OF THE PREFERRED EMBODIMENTS

With reference to the drawings, especially FIGS. 1 and 2, the reed cutter device 1 illustrated as an example essentially comprises a bed part 3 on which a reed 5 whose beveled end 7 is to be trimmed can be supported, a die and punch assembly 9 for cutting said beveled end 7 of the reed, a device 11 for centering the reed relative to said die and punch cutting assembly 9, and an actuating plunger 13 for the cutting of the reed 5.

The bed part 3, made with the translucent material Plexiglas is in the form of an approximately rectangular plate capable of supporting in an appropriate central longitudinal position 15 a reed 5 to be trimmed. This plate is of a small size, suitable to be held in a person's hand.

The reed 5 is positioned on the flat top face 17 of the bed part, being adjacent to the die and punch assembly 9 and to the actuating plunger 13 at its bevelled end part 7, and adjacent to the centering device 11 via one of its sides.

The reed centering device 11 comprises an L-shaped metal bar 19 along the edge of the bed part 3, with the long arm 21 of the L along the longitudinal edge of the bed part 3, adjacent to the reed 5, and with the short arm 23 of the L occupying a substantial part (a little more than one half) of the length of the edge of the base 25 of the bed part 3. The reed 5 rests against this bar 19 via three bearing points formed by rounded regions projecting from the bar, namely a point 27 close to the beveled end 7 of the reed and two other points close to the base of the reed, one a lateral point 29 and the other 31 a point below the base of the reed.

This bar 19 is movable, its movements being controlled by two external rotary wheels operated by the user's finger. Movements transverse to the longitudinal axis of the reed are controlled by a smaller wheel 33 at the end of the long arm 21 of the L, near the beveled end 7 of the reed. Another wheel 35 (slightly larger) is located at the angle of the arms 21, 23 of the L, close to the base of the reed 5. These wheels 33, 35 each have an index marker 33a, 35a, respectively so that by rotating them it is possible to adjust the length of cut of the end 7 of the reed to the desired length and, for example, set the desired strength to which to trim the reed (for example a half strength).

These wheels 33, 35 are each mounted on a rotatable pin mounted in the bed part 3 and provided with an eccentric cam 33b, 35b in a corresponding bore 37, 39 passing through the bar 19 (FIGS. 2, 3). That bore 37 of the bar which corresponds to the smaller wheel 33 is elongated longitudinally parallel to the central longitudinal axis of the reed 5, thus allowing the bar 19 to be shifted in a direction parallel to this longitudinal axis of the reed, while that bore 39 of the bar which corresponds to the corner wheel 35 of the bar is extended transversely, at right angles to the longitudinal axis of the reed 5, allowing the bar 19 to be shifted in a direction perpendicular to the longitudinal axis of the reed 5.

Axial longitudinal guidance of the bar 19 is supplemented by a rod 41 mounted on the bed part 3 close to the base of the reed 5 in a through-bore 43 which is elongated in the direction of the longitudinal axis of the bar.

The die and punch assembly 9 comprises a fixed die 45 (seen through the bed in FIG. 3) located just below the plane in which the reed 5 sits, in line with its beveled end 7; and a movable punch 47 mounted with its rounded cutting line 49 over the complementary cutting line 51 of the die 45 in a plane perpendicular to the longitudinal axis of the reed 5.

The punch 47 slides relative to the bed part 3 at the end of the latter, being connected to the actuating plunger 13 by two pillars 53 perpendicular to the plane of the bed. The pillars 53 slide in mating (allowing for the tolerance) bore rings 55 fitted within the thickness of the bed part 3.

The plunger 13 is a small rectangular-shaped top plate on which the operator can place a finger, its longitudinal edges comprising each of said punch slide pillars 53.

This plunger 13 is returned to the top position by a central helical spring 57 attached to the plunger plate 13 and resting on the bed part in a corresponding recess.

Operation of the reed cutter device will be immediately obvious from the above description.

The operator places a reed 5 to be trimmed on the reed cutter device 1, in its position 15, snugly against said bar 19.

This reed 5 therefore bears against the three rounded contact regions 27, 29, 31 of the bar laterally against two contact points 27, 29 and at its base via a point 31. The operator now turns the adjustment wheels 33, 35 to cut the reed in a desired manner. The device can be turned over to view the end of the reed 7 ready to be cut through the transparent bed, so that the adjustments can be verified, and once the adjustments are correct the operator simply pushes the plunger 13 down to cut the reed. The waste or cut end of the reed drops down under the bed part 3. Once cut, the trimmed reed 5 is simply removed by hand from its position 15 on the reed cutter device.

A variant of the reed cutter device of the invention is illustrated in FIG. 4.

In this reed cutter device 1′, the guide bar is replaced by three rotary eccentric wheels 33′, 34 and 35′, two 33′ and 34 of which bear against one side of the reed 5′ for the purposes of transverse adjustment of the reed, and one 35′ of which bears against the end of the reed 5′ for the longitudinal advance. These wheels are rotated to the desired setting.

The actuating plunger is replaced with a spring bridge 13′ with an actuating handle 14, comprising a lower punch 47′ which is actuated by pushing on the handle 14, and returns to the non-use position when released. The guide pillars 53′ of the punch may optionally be removed.

The invention thus provides a read cutter device that is simple both to adjust and to operate.

1. A reed cutter device for cutting the reeds of wind instruments, in which the body of the reed is held on a bed and the end of the reed is able to be cut by the die and punch cutting assembly for cutting to a suitable profile, comprising a device for centering the reed relative to said die and punch cutting assembly, provided with a means for advancing the reed longitudinally and with a means for adjusting the transverse position of the end of the reed on said bed, and the cutting assembly comprises a punch mounted movably relative to a fixed die mounted on the bed, the punch, which is mounted on an actuating plunger, being able to slide on an axis essentially perpendicular to the plane of the reed or to the plane of the bed.

2. The reed cutter device as claimed in claim 1, in which the adjustment of the longitudinal advance of the reed on its bed is done by means of a wheel mounted rotatably on said means of longitudinal advance.

3. The reed cutter device as claimed in claim 2, in which said wheel includes an index marker enabling the musician to adjust the strength of the reed to the desired level.

4. The reed cutter device as claimed in any one of the preceding claims, in which the setting of the transverse position of the end of the reed is done by means of a second wheel mounted rotatably on said means of adjustment of the transverse position.

5. The reed cutter device as claimed in claim 4, in which said wheel includes an index marker for the precise adjustment of the transverse position of the end of the reed before it is cut.

6. The reed cutter device as claimed in one of claims 2-5, in which said wheel for adjusting the longitudinal advance of the reed and said wheel for the transverse adjustment of the reed are both mounted on the same movable bar, which bears laterally on a single side through at least two points against the body of the reed, one at the point close to the beveled end of the reed and one point close to the base of the reed, and a third point below the base of the reed.

7. The reed cutter device as claimed in claim 6, in which the movements of said bar are controlled by means of said wheels, respectively transversely relative to the body of the reed, principally through said point close to the beveled end of the reed, and longitudinally through said point below the base of the reed.

8. The reed cutter device as claimed in one of claims 2-7, in which said wheels are each mounted with their axis passing through the bar and connected to the bed, each being provided with an eccentric part capable of bearing rotationally against a corresponding bore in the bar in order to move said bar along the longitudinal and transverse axes of movement of the reed.

9. The reed cutter device as claimed in claim 1, in which said means of longitudinal advance of the reed comprises at least one eccentric rotary wheel pressed against the end of the reed.

10. The reed cutter device as claimed in either of claims 1 and 11, in which said transverse setting means comprises two wheels set apart from one another, mounted rotationally and eccentrically and pressed against the side of the reed.

11. The reed cutter device as claimed in any one of the preceding claims, in which said punch slides on two pillars perpendicular to the plane of the bed and is returned to its non-use position with the lifting of the plunger by a spring means.

12. The reed cutter device as claimed in any one of the preceding claims, in which said bed is made of a transparent material, e.g. a hard transparent plastic such as Plexiglas.

13. The reed cutter device as claimed in any one of the preceding claims, in which said punch is mounted on a spring bridge which can be moved down to the use position and back up to the non-use position.

14. The reed cutter device as claimed in any one of the preceding claims, in which said plunger is a spring bridge with an actuating handle, comprising a lower punch which is actuated by pushing on the handle, and returns to the non-use position when released.
